(19) United States
(12) Patent Application Publication
(10) Pub. No.: US 2022/0024059 A1
(43) Pub. Date: Jan. 27, 2022

(54) PERSONAL PROTECTION EQUIPMENT SYSTEM

(71) Applicant: Brian Hodapp, North Mankato, MN (US)

(72) Inventor: Brian Hodapp, North Mankato, MN (US)

(21) Appl. No.: 17/378,934

(22) Filed: Jul. 19, 2021

Related U.S. Application Data
(60) Provisional application No. 63/061,246, filed on Aug. 5, 2020.
(60) Provisional application No. 63/054,306, filed on Jul. 21, 2020.

(51) Int. Cl. B25J 21/02; A41D 19/015

(52) U.S. Cl. CPC B25J 21/02; A41D 19/015

(57) ABSTRACT

A personal protection system can include a membrane including a body, a first glove, and a second glove. The body can be positionable around a frame. The body can define an internal volume and can define a closed portion including a closed end. The body can define an open portion opposite the closed end, where the open portion can be configured to receive the frame into the internal volume. The first glove and the second glove can be connected to the closed end and can extend away from the open portion. The first glove and the second glove can be configured to invert into the internal volume when the frame is positioned within the internal volume.

### CLAIM OF PRIORITY

This patent application claims the benefit of priority, under 35 U.S.C. Section 119(e), to Brian Hodapp U.S. Patent Application Ser. No. 63/061,246, entitled “PERSONAL PROTECTION EQUIPMENT SYSTEM,” filed on Aug. 5, 2020 (Attorney Docket No. 5645.001PV2), and claims the benefit of priority, under 35 U.S.C. Section 119(e), to Brian Hodapp U.S. Patent Application Ser. No. 63/054,306, entitled “PERSONAL PROTECTION EQUIPMENT SYSTEM,” filed on Jul. 21, 2020 (Attorney Docket No. 5645.001PRV), each of which is hereby incorporated by reference herein in its entirety.

### BACKGROUND

Personal protection equipment (PPE) is often used during medical procedures to help protect patients and care providers from exposure to bacteria and communicable diseases. PPE can be positionable around a care provider or patient and can be made of materials configured to prevent or limit exchange of air or fluids between a patient and the care provider, such as a doctor, nurse, or other physician, which can help limit transmission of communicable diseases or viruses.

### BRIEF DESCRIPTION OF THE DRAWINGS

The patent or application file CONTAINS AT LEAST ONE DRAWING EXECUTED IN COLOR. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a perspective view of a membrane for a PPE system.

FIG. 2 illustrates a perspective view of a PPE system.

FIG. 3 illustrates a perspective view of a PPE system.

FIG. 4 illustrates a perspective view of a PPE system.

FIG. 5 illustrates a perspective view of a PPE system.

FIG. 6 illustrates a top view of a membrane for a PPE system.

FIG. 7A illustrates a top view of a membrane for a PPE system.

FIG. 7B illustrates a top view of a membrane for a PPE system.

### DETAILED DESCRIPTION

In some scenarios, such as a virus pandemic, PPE can be used by medical professionals when handling patients within a hospital, such as an intensive care unit (ICU). Some patients may require intubation or oral care while under the care of the physician. However, such procedures require opening of the oral cavity of a patient which can significantly increase risk of transmission of the virus from the patient to the physician. Similarly, dental procedures performed by dentists require opening of the oral cavity of a patient which can significantly increase risk of transmission. In other cases, simply breathing by the patient may generate sufficient risk of transmission of a communicable disease.

This disclosure can help to address these problems by providing a PPE membrane with integral gloves and a PPE system including a frame and such a membrane. While lying on a bed or table, a head of a patient can be received into the frame and a membrane can be positioned around the frame and can extend down to a torso of the patient to enclose the head of the patient and a portion of the patient's torso. An open end of the membrane can be secured around the patient's torso or waist and oxygen (or air) can be provided to the patient through the open end or ports in the membrane. The membrane can include two or more gloves that are configured to extend into the frame such that a physician or other health care provider can access the patient through the membrane, allowing the physician or provider to perform procedures on the patient without physical contact and while separated by the membrane, which can be impermeable (or semi-impermeable). Such separation can help to reduce risk of virus transmission from the patient to the physician.

Prior attempts to provide films around frames have required care providers to cut slits in the film to access the cavity holding the patient. This presents safety issues since the slits introduce new openings in the film through which a virus may transmit. The present disclosure helps to address this problem by providing a membrane with integral gloves, a cost-effective process for manufacturing the membrane, and an efficient technique for installing the membrane around in a frame in a care setting.

The above discussion is intended to provide an overview of subject matter of the present patent application. It is not intended to provide an exclusive or exhaustive explanation of the invention. The description below is included to provide further information about the present patent application.

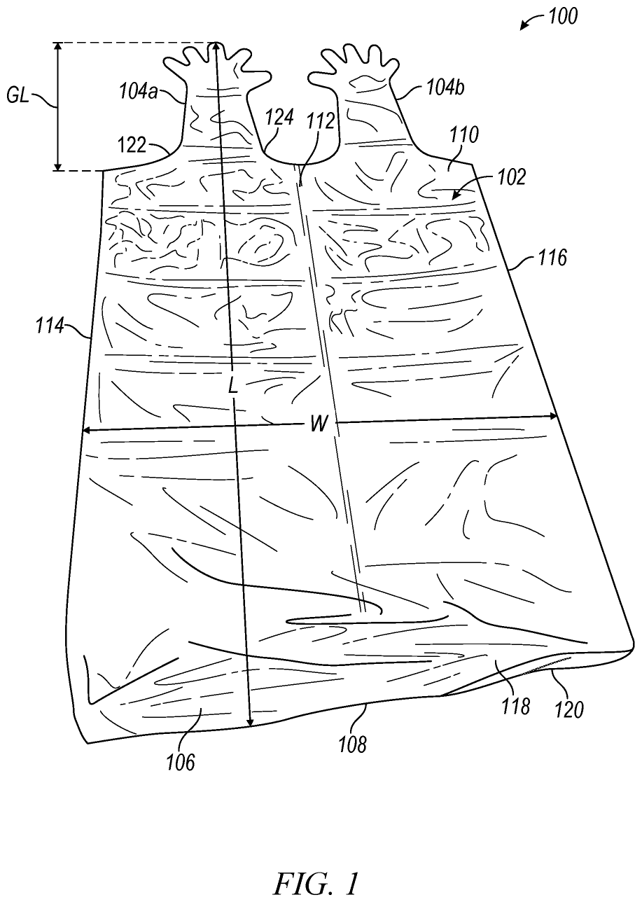

FIG. 1 illustrates a perspective view of a membrane 100 for a PPE system. The membrane 100 can include a body 102, gloves 104a and 104b, an open portion 106 (including an open end 108), a closed portion 110 (including a closed end 112), a first side 114, and a second side 116. The first side 114 and second side 116 can be closed along their entirety as illustrated in the figures. In other examples, the sides may be partially open at their ends adjacent the open end 108 to provide additional access through the open portion 106.

The membrane 100 can be a membrane configured to be positioned over a frame, as discussed in further detail below. The membrane 100 can be impermeable or semi-impermeable. The membrane 100 can be made of polymers such as one or more of low-density polyethylene (LDPE), high-density polyethylene (HDPE), polyethylene terephthalate (PETE), polyethylene (PE), polylactic acid (PLA), or the like. The membrane 100 can be made of other materials in other examples, such as naturally occurring or recycled materials.

The membrane 100 can be formed from a first film 118 and a second film 120 positioned on top of each other. In a manufacturing process, a die can be positioned over the first polymer film 118 and the second polymer film 120 and the die can be lowered to cut the films 118 and 120 and to seal the films around a perimeter of the films 118 and 120. The cutting and sealing operation can form the sides 114 and 116 and the closed portion 110 including the closed end 112 and the gloves 104a and 104b. In other examples, the die may cut the film and a separate heat sealer may seal the two films together along a closed portion. In some examples, the films 118 and 120 can be connected or sealed along the sides 114 and 116 prior to cutting with the die. In some examples, the membrane 100 can be made of a single film or single piece or sheet of polymer, such as a folded sheet, or a hollow cylindrical sleeve.

Once the films 118 and 120 are sealed, the open portion 108 can be cut or otherwise opened to form the open end 110. In some examples, the die can cut a perforation through the films 118 and 120 in the open portion 108 such that the open end 110 can be formed by ripping, tearing, or otherwise separating an excess portion from the open portion 108. That is, an entirety of a perimeter of the membrane 100 can be sealed except for the open end 106. In other examples, rather than sealing the films along their entire perimeter and opening the open end by, e.g., cutting, the die or heat sealer may seal the closed portions of the perimeter of the films and leave the open end 106 unsealed.

The thickness of the films can vary depending on the application of the PPE system. In the illustrated example, the films 118 and 120 can each have a thickness between 0.025 millimeters (1 mil or 1 thousandth of an inch) and 0.125 millimeters (5 mils or 5 thousandths of an inch). In some examples, the films can have a thickness between 1 mil and 3 mils. In some examples, the films 118 can have a thickness of 2 mils.

The first glove 104a and the second glove 104b can be connected to the closed portion 110 such as at the closed end 112. The first glove 104a and the second glove 104b can extend away from the open portion 106. The first glove 104a can be connected to the body 102 by curved portions 122 and 124, which can help to allow the first glove 104a extend into a volume of the membrane 100, as discussed further below. The second glove 104b can also be connected to the body 102 by curved portions. The curved portions may be semi-circular or elliptical in shape for example.

The sidewalls 114 and 116 can extend between the open portion 106 and the closed portion 110 and can be sealed. The sidewalls 114 and 116 can define a width W that can be between 70 and 100 centimeters. In some examples, the width W can be between 85 and 95 centimeters. In some examples, the width W can be about 90 centimeters. The body 102 can open to a circumference of about 170 centimeters to 190 centimeters. In some examples, the body 102 can open to a circumference of about 180 centimeters.

The gloves 104 and the open portion 106 can define a length L, which can be between 125 and 225 centimeters. In some examples, the length L can be between 150 and 200 centimeters. In some examples, the length L can be about 175 centimeters. The gloves 104 can each have a length GL between 40 and 80 centimeters. In some examples, the gloves 104 can have a length GL of between 45 and 70 centimeters.

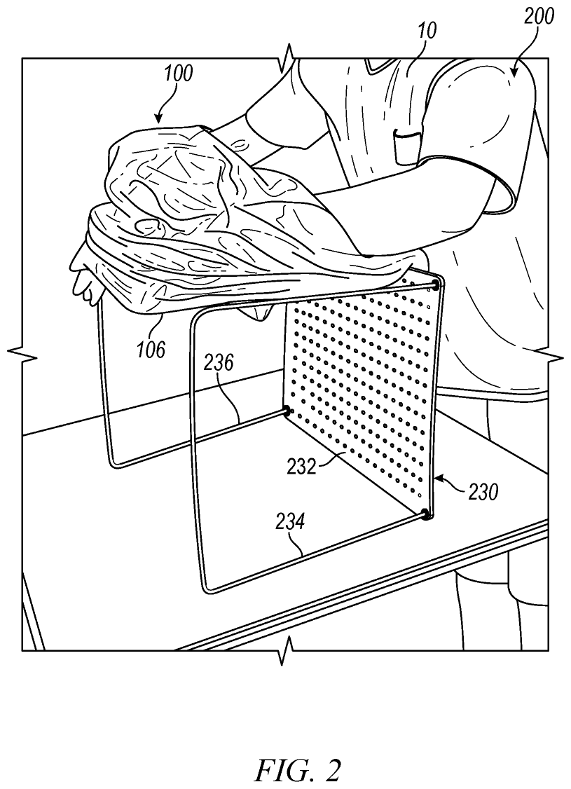

Use and operation of the membrane are discussed below with respect to FIGS. 2-5.

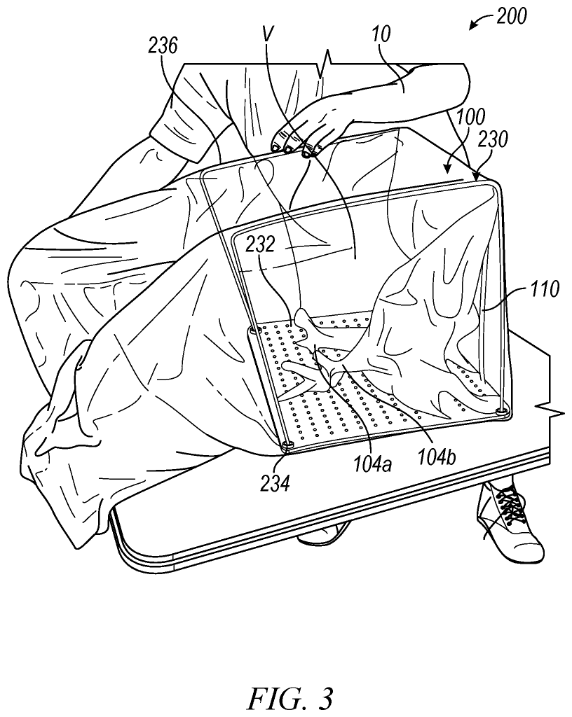

FIGS. 2 and 3 illustrate a perspective view of a PPE system 200 which can include the membrane 100 and a frame 230. Also shown in FIGS. 2 and 3 is a user 10. FIGS. 2 and 3 are discussed together below.

The membrane 100 can be similar to the membrane 100 discussed above. The frame 230 can include a base 232 and supports 234 and 236. In some examples, the base 232 can be omitted and the supports 234 and 236 can be connected by additional supports or can include interconnecting support members. The components of the frame 230 can be made of materials such as one or more of metals, plastics, foams, elastomers, ceramics, composites, or the like.

The base 232 can be a rigid or semi-rigid platform configured to receive a patient's head thereon. The base 232 can have a substantially rectangular shape, but can have other shapes in other examples. The supports 234 and 236 can be connected to the base at one or more locations and can extend therefrom. The supports 234 and 236 can be connected to each other in some examples. The support 234 can, together with the base 232, define a hollow rectangular shape. Similarly, the support 236, together with the base 232, can define a hollow rectangular shape. Together, the components of the frame 230 can form a lattice or structure that is lightweight and configured to support the membrane 100 thereon while being sized to receive a head of a patient therein.

With reference to FIG. 2, the PPE membrane with integral gloves provides an efficient way of installation about a frame. In the example, the open portion 106 of the membrane 100 can be positioned such that the supports 234 and 236 and the base 232 are received through the open portion 106. The user can, for example, quickly insert their hands into the gloves, reach through the frame and then, with their hands inside the frame and perhaps holding on to a portion of the frame, the user may pull the open end about the frame, leaving the gloves inverted and within the frame. In this way, sealed gloves can be provided inside the frame without the need for a user to cut slits in the membrane to access the inside of the frame. The frame 230 can be positioned within a volume V of the membrane 100, as shown in FIG. 3. More specifically, as further shown in FIG. 3, the frame 230 can be positioned in the volume V near (or adjacent or contacting) the gloved-side of the closed portion 110 of the membrane 100, opposite the open portion 106. When the frame 230 is positioned within the membrane 100, the gloves 104 can be positioned at an open portion of the frame 230, such as an end of the frame 230. The gloves 104a and 104b be can be inverted into the volume B and within the frame 230, such as between the supports 234 and 236.

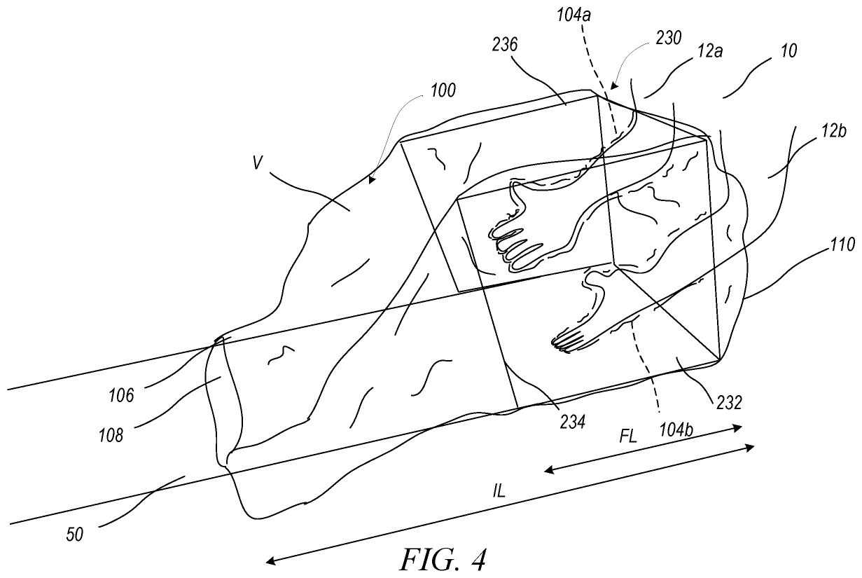

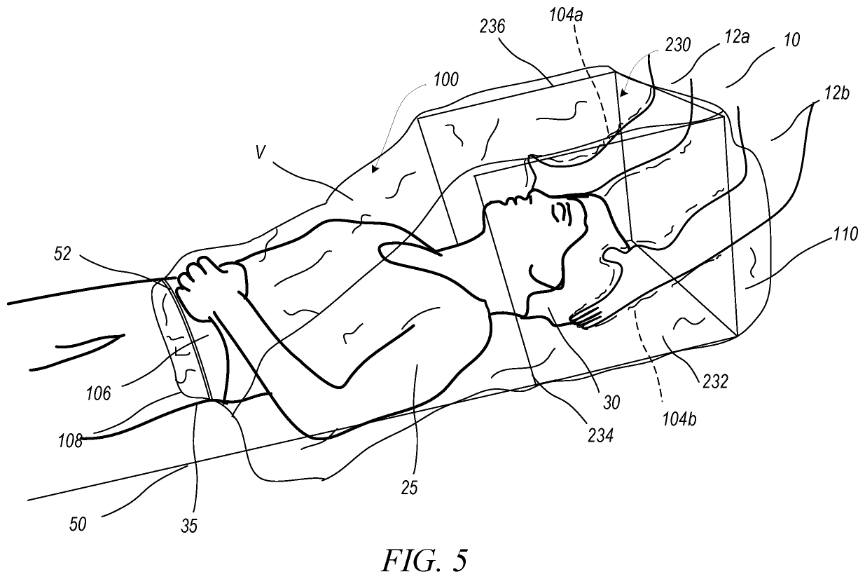

FIGS. 4 and 5 illustrate a perspective view of a PPE system 200, which can include the membrane 100 and the frame 230. FIGS. 4 and 5 also show a bed or table 50 and the user 10, including arms 12a and 12b. FIG. 5 also shows a patient 25 including a head 30, and a waist 35. FIGS. 4 and 5 are discussed below together.

As shown in FIG. 4, the frame 230 and membrane 100 can be positioned on the table 50, such as following installation of the membrane 100 on the frame.

When the membrane 100 is installed on the frame 230, the membrane 100 can have an installed length IL that is longer than a frame length FL of the frame 230 such that the membrane 100 extends beyond the frame 230. In some examples, the FL can be smaller (e.g., between 35 and 45 cm) than the glove length (e.g., between 45 and 55 cm) and the IL (e.g., 75 to 125 cm) can be larger than the FL (e.g, between 70 and 80 cm).

As also shown in FIG. 4, the first glove 104a and the second glove 104b can be configured to invert into the internal volume V of the membrane 100 when the frame 230 is positioned within the internal volume V of the membrane. The user 10 can then insert his or her arms 12a and 12b into the gloves 104a and 104b, respectively, to access the internal volume V of the membrane 100. The membrane 100 can be substantially transparent or translucent, which can allow the user 10 to see through the membrane 100, such as during a procedure.

As shown in FIG. 5, the patient 25 can be positioned through the open end 108 of the membrane 100, into the internal volume V of the membrane, and into the frame 230. The head 30 of the patient 25 can be positioned near the closed portion 110 such that the head 30 of the patient 25 is resting on the platform 232. In this position, the user 10 can access the patient 25 through the gloves 104a and 104b.

Once the patient 25 is positioned, as desired, with respect to the membrane 100 and the frame 230, the open portion 106 can be secured around the waist 35 of the patient 25 using a band 52. Other fasteners, such as a tie, wrap, or the like, can be used. In other examples, the open portion 106 can be secured around legs of the patient 25 or a torso of the patient, depending on a height of the patient and a length of the body 102 of the membrane.

The position of the membrane 100 relative to the patient 25 shown in FIG. 5 can create a barrier between the patient 25 and the user 10, such as a physician. When the patient 25 is positioned within the volume V of the membrane, oxygen or air may be provided, such as through one or more tubes running through the open end of the membrane 100 or running through ports in the membrane that may be provided during manufacturing or by a user in real time. This can allow the patient 25 to breath normally in close proximity to the user 10 while the membrane 100 helps to greatly reduce risk of virus transmission during procedures such as dental procedures or intubation procedures that require access to the oral cavity of the patient 25.

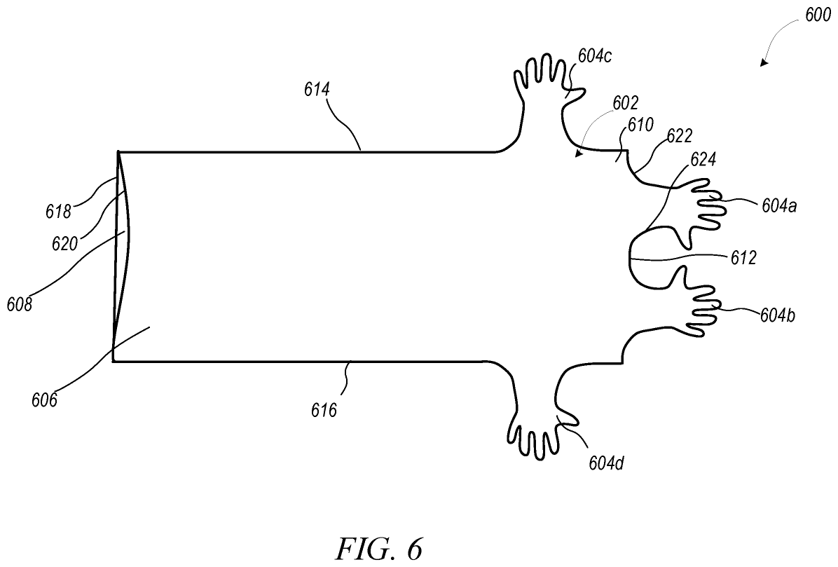

FIG. 6 illustrates a top view of a membrane 600 for a PPE system including four gloves. Any of the previously discussed membranes can be modified to include 3, 4, or more gloves. The membrane 600 can include a body 602 and gloves 604a, 604b, 604c, and 604d. The body 602 can include an open portion 606 (defining an open end 608) and a closed portion 610 (defining a closed end 612). The body 602 can also include sides 614 and 616 (or sidewalls 614 and 616). The membrane 600 can be made of films 618 and 620.

The membrane 600 can be similar to the membrane 100 discussed above; the membrane 600 can additionally include the gloves 604c and 604d. The glove 604c can be located on the side 614 of the body 602 and can be configured to invert into the volume V. Similarly, the glove 604d can be located on the side 616 of the body 602 and can be configured to invert into the volume V. The gloves 604c and 604d can be located near the closed portion 610 such that the gloves 604c and 604d can help to provide access to a patient when the membrane 600 is positioned over a frame, such as the frame 230 of FIGS. 2-5.

Curved portions 622 and 624 connecting the glove 604a and 604b can be included on any of the gloves 604a-604d to help enable inversion of the gloves 604a-604d. Though the membrane 600 is shown as having four gloves, the membrane can be modified to include 1, 3, 4, 5, 6, 7, 8, or the like gloves.

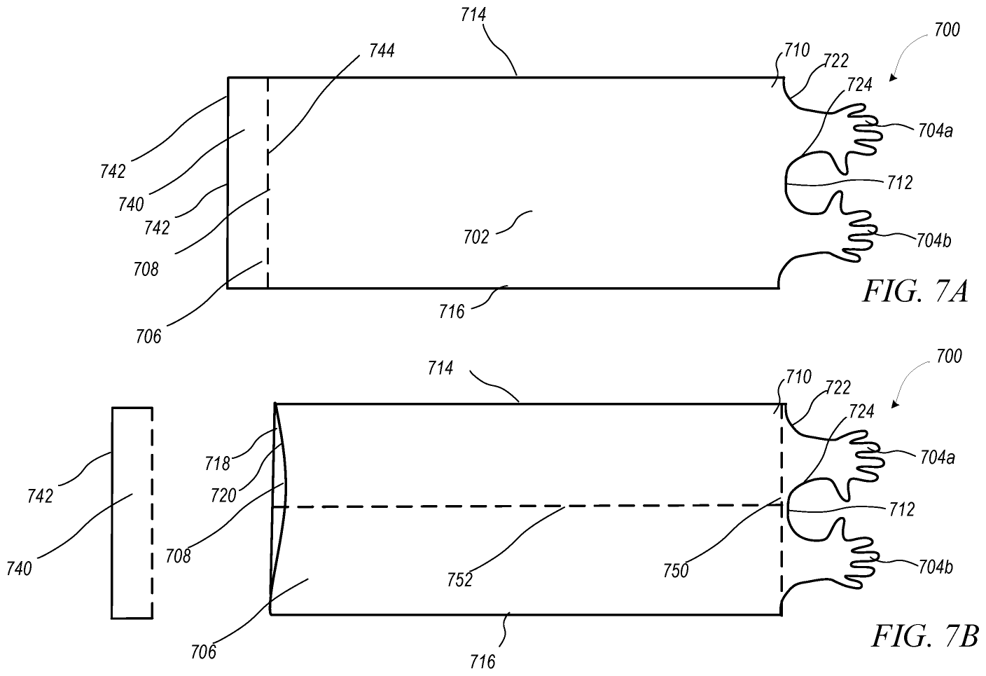

FIG. 7A illustrates a top view of a membrane 700 for a PPE system. FIG. 7B illustrates a top view of the membrane 700. The membrane 700 can include perforations at the open end. The membranes 100 and 600 can be modified to include such perforations.

The membrane 700 can be similar to the membranes 100 and 600 discussed above where like numerals can represent like components. The membrane 700 can include a separable portion 740. The separable portion can be a part of a first polymer film 718 and a second polymer film 720 of the membrane 700 and can be closed at an end 742. The separable portion 740 can be connected to the body 702 at an open portion 706 by perforations 744. The perforations 744 can be portions of the first polymer film 718 and a second polymer film 720 with a reduced thickness (or including holes or cuts or slots or slits) that are configured to tear to separate the separable portion 740 from the open portion 740 to open the open end 708.

As show in FIG. 7A, the separable portion 740 can be provided as attached to the body 702, where a closed end 742 of the separable portion 740 can be closed prior to separation, which can help limit tampering and can help maintain sterility of the membrane 700, such as during transportation and setup of the membrane. Inspection of the separable portion 740 prior to use in a procedure to determine whether the separable portion 740 is completely attached can also help to prevent reuse of the membrane 700, such as when reuse is not desired.

When it is desired to use and install the membrane 700 (such as prior to a procedure, as discussed with respect to FIGS. 2-5), the separable portion 740 can be torn at the perforations 744, such as using a force that is reduced from a force required to tear the membrane 700 without the perforations. When the separable portion 740 is torn from the body 702 at the open portion 706, the open end 708 can be formed such that the first polymer film 718 and the second polymer film 720 are separated to form the open end 708. The separable portion 740 can be disposed or recycled following separation from the body 702 and the body 702 can be placed over a frame as discussed above with respect to FIGS. 2-5.

In some examples, other portions of the membrane 700 can include a perforation to separate other portions of the membrane. For example, perforations 750 can be included in the closed portion 710 which can allow the gloves 704 to be separated from the closed end 710. Such a perforation can be useful when quick access to the patient is required, such as during an emergency event. A perforation 752 can also be included down a length of the membrane, which can be useful for removal of the membrane 700 from the frame, such as for disposal after use of the membrane 700 during a procedure.

### Notes and Examples

The following, non-limiting examples, detail certain aspects of the present subject matter to solve the challenges and provide the benefits discussed herein, among others.

Example 1 is a personal protection system comprising: a membrane comprising: a body positionable around a frame, the body defining: an internal volume; a closed portion including a closed end; and an open portion opposite the closed end, the open portion configured to receive the frame into the internal volume; and a first glove and a second glove connected to the closed end and extending away from the open portion, the first glove and the second glove configured to invert into the internal volume when the frame is positioned within the internal volume.

In Example 2, the subject matter of Example 1 optionally includes wherein the membrane is impermeable.

In Example 3, the subject matter of any one or more of Examples 1-2 optionally include the body comprising: a first sidewall extending between the closed end and the open portion; and a third glove connected to the first sidewall, the third glove configured to invert into the internal volume when the frame is positioned within the internal volume.

In Example 4, the subject matter of Example 3 optionally includes the body comprising: a second sidewall extending between the closed end and the open portion opposite the first sidewall; and a fourth glove connected to the second sidewall, the fourth glove configured to invert into the internal volume when the frame is positioned within the internal volume.

In Example 5, the subject matter of any one or more of Examples 1-4 optionally include wherein the membrane has a thickness between 0.025 millimeters and 0.075 millimeters.

In Example 6, the subject matter of any one or more of Examples 1-5 optionally include wherein the membrane defines a length and a width, and wherein the length is greater than the width.

In Example 7, the subject matter of Example 6 optionally includes wherein the width is between 85 and 95 centimeters.

In Example 8, the subject matter of any one or more of Examples 6-7 optionally include wherein the length is between 150 and 200 centimeters.

In Example 9, the subject matter of any one or more of Examples 6-8 optionally include wherein the first glove has a length of between 45 and 70 centimeters.

In Example 10, the subject matter of any one or more of Examples 1-9 optionally include wherein the first glove and the second glove are located at a center of the closed end.

In Example 11, the subject matter of any one or more of Examples 1-10 optionally include wherein the first glove is connected to the body by a first curved portion on a first side of the first glove and a second curved portion on a second side of the first glove.

In Example 12, the subject matter of any one or more of Examples 1-11 optionally include wherein the body is formed of a first polymer film layer and a second polymer film layer, the first polymer film layer and the second polymer film layer sealed together along the closed end and around the first glove and the second glove.

In Example 13, the subject matter of any one or more of Examples 1-12 optionally include wherein the body opens to a circumference of 170 centimeters to 190 centimeters.

Example 14 is a personal protection system comprising: a frame configured to receive at least a portion of a head of a patient therein; and a membrane positionable around the frame and at least partially defining an internal volume, the membrane comprising: a closed portion including a closed end; an open portion opposite the closed end, the open portion configured to receive the frame into the internal volume and configured to receive the patient into the internal volume; and a first glove and a second glove connected to the closed end and positionable into the internal volume to provide access to the patient through the membrane.

In Example 15, the subject matter of Example 14 optionally includes wherein the membrane is a unitary piece.

In Example 16, the subject matter of any one or more of Examples 14-15 optionally include wherein the gloves are configured to extend into the frame from the closed end, opposite the open end.

In Example 17, the subject matter of any one or more of Examples 14-16 optionally include wherein the membrane defines a membrane length, wherein the frame defines a frame length, and wherein the membrane length is larger than the frame length such that the membrane extends beyond the frame when the membrane is positioned near the closed portion.

In Example 18, the subject matter of Example 17 optionally includes wherein the membrane is positionable around a torso, legs, or waist of a patient.

Example 19 is a method of installing a personal protection system comprising: providing a frame configured to receive at least a portion of a head of a patient therein; and inserting the frame into an open portion of a body of a polymer membrane; positioning the frame into a volume of the membrane near a closed portion of the membrane opposite the open portion; inverting gloves, the gloves connected to the closed portion of the membrane, to extend into the volume of the membrane; and positioning the gloves within the frame.

In Example 20, the subject matter of Example 19 optionally includes positioning the open portion around a torso, legs, or waist of the patient.

In Example 21, the subject matter of Example 20 optionally includes securing the open end around the torso, legs, or waist of the patient.

Example 22 is a method of manufacturing a membrane of a personal protection system, the method comprising: providing a first polymer film and a second polymer film on top of the first polymer film; positioning a die over the first polymer film and the second polymer film; cutting and sealing the first polymer film and the second polymer film together using the die to form a closed end including a first glove and a second glove extending from the closed end; and opening an open end of the membrane opposite the closed end.

In Example 23, the subject matter of Example 22 optionally includes wherein cutting and sealing is performed using a die that cuts and seals.

In Example 24, the subject matter of any of one or more of Example 22-23 optionally include wherein cutting and sealing is performed using a die for cutting and a separate heat sealer for sealing.

In Example 25, the subject matter of any of one or more of Example 22-24 optionally include wherein cutting and sealing includes leaving an open end in the membrane opposite the closed end with the gloves.

In Example 26, the subject matter of any of one or more of Example 22-25 optionally includes wherein cutting and sealing includes sealing the end opposite the gloves, and the method further includes opening the open end of the membrane opposite the closed end.

In Example 27, the subject matter of any of one or more of Example 22-26 optionally includes wherein the first film and the second film are transparent or translucent.

In Example 28, the subject matter of any one or more of Examples 22-27 optionally include wherein the first film and the second film have a thickness between 0.025 millimeters and 0.075 millimeters.

In Example 29, the subject matter of any one or more of Examples 22-28 optionally include wherein an entirety of a perimeter of the first polymer film and the second polymer film is sealed except for the open end.

Example 30 is a personal protection system comprising: a membrane comprising: a body positionable around a frame, the body defining an internal volume and including a closed portion including a closed end; a separable portion connected to the body including perforations connecting the separable portion to the body, the separable portion separable from the body at the perforations to create an open portion opposite the closed end, the open portion configured to receive the frame into the internal volume; and a first glove and a second glove connected to the closed end and extending away from the open portion, the first glove and the second glove configured to invert into the internal volume when the frame is positioned within the internal volume.

In Example 31, the apparatuses or method of any one or any combination of Examples 1-30 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A personal protection system comprising:
a membrane comprising:
a body positionable around a frame, the body defining:
an internal volume;
a closed portion including a closed end; and
an open portion opposite the closed end, the open portion configured to receive the frame into the internal volume; and
a first glove and a second glove connected to the closed end and extending away from the open portion, the first glove and the second glove configured to invert into the internal volume when the frame is positioned within the internal volume.

2. The system of claim 1, wherein the membrane is impermeable.

3. The system of claim 1, the body comprising:
a first sidewall extending between the closed end and the open portion; and
a third glove connected to the first sidewall, the third glove configured to invert into the internal volume when the frame is positioned within the internal volume.

4. The system of claim 3, the body comprising:
a second sidewall extending between the closed end and the open portion opposite the first sidewall; and
a fourth glove connected to the second sidewall, the fourth glove configured to invert into the internal volume when the frame is positioned within the internal volume.

5. The system of claim 1, wherein the membrane has a thickness between 0.025 millimeters and 0.075 millimeters.

6. The system of claim 1, wherein the membrane defines a length and a width, and wherein the length is greater than the width.

7. The system of claim 6, wherein the width is between 85 and 95 centimeters.

8. The system of claim 6, wherein the length is between 150 and 200 centimeters.

9. The system of claim 6, wherein the first glove has a length of between 45 and 70 centimeters.

10. The system of claim 1, wherein the first glove and the second glove are located at a center of the closed end.

11. The system of claim 1, wherein the first glove is connected to the body by a first curved portion on a first side of the first glove and a second curved portion on a second side of the first glove.

12. The system of claim 1, wherein the body is formed of a first polymer film layer and a second polymer film layer, the first polymer film layer and the second polymer film layer sealed together along the closed end and around the first glove and the second glove.

13. The system of claim 1, wherein the body opens to a circumference of 170 centimeters to 190 centimeters.

14. A personal protection system comprising:
a frame configured to receive at least a portion of a head of a patient therein; and
a membrane positionable around the frame and at least partially defining an internal volume, the membrane comprising:
a closed portion including a closed end;
an open portion opposite the closed end, the open portion configured to receive the frame into the internal volume and configured to receive the patient into the internal volume; and
a first glove and a second glove connected to the closed end and positionable into the internal volume to provide access to the patient through the membrane.

15. The system of claim 14, wherein the membrane is a unitary piece.

16. The system of claim 14, wherein the gloves are configured to extend into the frame from the closed end, opposite the open end.

17. The system of claim 14, wherein the membrane defines a membrane length, wherein the frame defines a frame length, and wherein the membrane length is larger than the frame length such that the membrane extends beyond the frame when the membrane is positioned near the closed portion.

18. The system of claim 17, wherein the membrane is positionable around a torso, legs, or waist of a patient.

19. A personal protection system comprising:
a membrane comprising:
a body positionable around a frame, the body defining an internal volume and including a closed portion including a closed end;
a separable portion connected to the body including perforations connecting the separable portion to the body, the separable portion separable from the body at the perforations to create an open portion opposite the closed end, the open portion configured to receive the frame into the internal volume; and
a first glove and a second glove connected to the closed end and extending away from the open portion, the first glove and the second glove configured to invert into the internal volume when the frame is positioned within the internal volume.

20. The system of claim 19, wherein the membrane is impermeable.
